(19) United States
(12) Patent Application Publication
(10) Pub. No.: US 2005/0114139 A1
(43) Pub. Date: May 26, 2005

(54) Method of operating a speech dialog system

(76) Inventor: Gokhan Dincer, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/505,501

(22) PCT Filed: Feb. 21, 2003
(86) PCT No.: PCT/IB03/00643

(30) Foreign Application Priority Data
Feb. 26, 2002 (DE) 102 08 295.2

(51) Int. Cl. G10L 21/00

(52) U.S. Cl. 704/270

(57) ABSTRACT

A method is described for operating a speech dialog system, which communicates with a user using a speech recognition device and a speech output device, wherein the speech dialog system transmits to the user data detected and/or generated for the user by the speech dialog system on the basis of the dialog. According to the invention, after receiving a user's transmission mode select command, the speech dialog system formats the data to be transmitted to the user in a data format suitable for the selected transmission mode and sends the data over an interface suitable for this transmission mode. An appropriate speech dialog system is also described.

The invention relates to a method of operating a speech dialog system, which communicates with a user using a speech recognition device and a speech output device, wherein the speech dialog system transmits to the user data detected and/or generated for the user on the basis of the dialog.

The invention additionally relates to a corresponding automatic speech dialog system and a computer program with program code means, for performing the method.

Speech dialog systems, which communicate with a user using a speech recognition and a speech output device, have already been known for some time. They are voice activated automatic systems, which are often also known as voice portals or speech applications. Such a speech dialog system may comprise special terminals, at which the user has to be located in order to be able to communicate with the speech dialog system, as for example a stationary information system in an airport or the like. However, speech dialog systems are frequently systems having a connection to a public communication network or the like, such that the speech dialog systems may be used for example by means of a normal telephone, a cell phone or a PC with telephony function etc. Examples of such speech dialog systems are automated call answering and information systems, as now used for example by some larger companies, organizations and offices in order to supply a caller as quickly and conveniently as possible with the desired information or to connect him/her with an office which is in a position to respond to the caller's specific requests. Further examples are automated directory inquiries, as used already by some telephone companies, an automated timetable or flight schedule information service or an information service giving general event details, for example movie theater and theater programs, for a particular locality. In addition to merely providing or finding information for the user and transmitting it to the user as required, some speech dialog systems also offer additional services, such as for example a booking service for train or plane seats or hotel rooms, a payment service or a goods ordering service. Likewise, of course, combinations of a wide range of information and service systems are possible, for example a complex speech dialog system in which the user has firstly to decide which service he/she would like to take advantage of and is then transferred to the desired service. Consequently, it is in principle possible, as on the Internet for example, for any desired services to be offered to the user over such a speech dialog system. However, a speech dialog system has the advantage that the user merely requires a normal telephone or a cell phone in order to use the services. On the other hand, however, such a speech dialog system has the disadvantage that the data detected or generated for the user on the basis of the dialog with the user, i.e. a dialog result or intermediate result (the desired information in the case of an information system for example or booking confirmation in the case of a booking system), are only output acoustically to the user within the dialog by means of the speech output device. The user has then either to remember or to write down the information output as quickly as possible, for example a telephone number retrieved in the event of an information request, in order to be able to use this information later. In the case of services which involve commercial transactions which may be legally binding, such as in the case of booking services or electronic department stores for example, the user does not have any written confirmation which he/she could use as proof for example in the event of problems.

It is an object of the present invention to provide an improved method of operating a dialog system and a corresponding dialog system with which these disadvantages are avoided.

This object is achieved by a method of the above-mentioned type, which is characterized in that, after receiving a user's transmission mode select command, the speech dialog system formats the data to be transmitted to the user in a data format suitable for the selected transmission mode and sends them over an interface suitable for this transmission.

The user thus has the choice, by inputting the transmission mode select command, to have the data sent by any other desired transmission mode than speech output, for example by fax, as an email, by SMS or via another short message service. Transmission by another transmission mode may be selected in addition to or as an alternative to speech output. Thus, the user has the option of receiving data relevant to him/her in a form which allows him/her no longer to write information down or which provides him/her with written proof. Thus, in the case of a directory enquiry's service according to the invention, the user may for example advantageously have the found telephone number sent directly by SMS to his/her cell phone, such that he/she may optionally enter this number directly into the electronic telephone book of the cell phone and/or immediately dial the number.

An automatic speech dialog system according to the invention has accordingly to comprise, in addition to a speech recognition device and a speech output device for communication with the user as well as means for detecting and/or generating particular data for the user as a function of the dialog with the user and transmitting them to the user, at least one formatting device for formatting the data in a data format suitable for a further transmission mode in addition to or as an alternative to speech output. Furthermore, the speech dialog system requires a control means for receiving a user's transmission mode select command via the speech recognition device for selection of a transmission mode and for controlling the speech dialog system in such a way that, as a function of the transmission mode select command, the data are formatted by means of the appropriate formatting device in accordance with the selected transmission mode and sent over a suitable interface.

The dependent claims each contain particularly advantageous embodiments and further developments of the invention.

As interfaces for transmission of the data to the user, the speech dialog system may on the one hand comprise separate interfaces for the individual transmission modes, for example a telephone connection and a separate Internet connection etc. On the other hand, a multifunctional interface may also be used, which is activated appropriately by a control device and ensures that the data are sent over the correct channel for the transmission mode and using the correct protocol. Any desired standardized protocol suitable for the transmission mode may be used which is supported by the relevant network or the receiving apparatus. Examples thereof are the standards H.323 or T1 for data transmission over the Internet or the telecommunications standard SS7 or C7.

The transmission mode select command is transmitted within the dialog, i.e. by speech input by the user. To this end, the dialog system may previously output an appropriate input request, i.e. a so-called “prompt”, to the user, with which the user is asked, for example, in which mode particular data should be transmitted. An example of such a prompt in the case of the output of a found telephone number is “Should I say the number or do you want it to be transmitted by email, SMS or fax?”.

However, it is also possible for the user to give a transmission mode select command of his/her own volition, i.e. unasked, which will be understood by the speech dialog system. In the case of an appropriately powerful speech recognition device, this transmission mode select command may also be detected from a continuous sentence or sentence sequence optionally with the aid of the context provided by all the previous dialog. Thus, the user could give the following instruction, for example: “I wish to make a booking and receive confirmation by fax”. In this case, the speech recognition device and/or the data transmission control device have to be appropriately designed to recognize and process particular keywords within continuous text, in the above example the words “confirmation by fax”.

In one example of embodiment, the additional option is provided that the transmission mode select command may indicate a plurality of transmission modes. In this case, the user may for example select for the desired information to be sent both by SMS to the cell phone used by the user to carry out the dialog and additionally to his/her fax machine to be printed out. The speech dialog system then sends the data in parallel or in succession by each of the indicated transmission modes.

If, in one selected transmission mode, transmission of the data is possible in different data formats, the data are formatted and sent preferably in accordance with a data format indicated by the user. The option of sending the data in various data formats in one transmission mode is available inter alia in the case of transmission as an email attachment. In this case, the data could be transmitted for example as a word processing file, a spreadsheet file or as a file from a particular database. If the user does not him/herself select a data format, the speech dialog system outputs a prompt to the user to input a data format select command.

In addition to the transmission mode, the speech dialog system has also to know the address to which the data are to be transmitted by the selected transmission mode, i.e. for the example the subscriber number of the connection at which the respective receiving terminal may be reached.

This information may be received by the speech dialog system in that the user transmits an address command explicitly to the speech dialog system. This address command may either be a complete address, for example an entry containing the fax number or email address, or it may consist of an entry by means of which the speech dialog system determines the full address using additional address information. An example of such an “incomplete” address command is the instruction “Send to my cell phone”. The necessary additional address information, in this example the subscriber number of the user's cell phone, may be determined by the speech dialog system inter alia using conventional caller identification methods. An example is the CLI (Calling Line Identification) method.

In a further preferred example of embodiment, user profiles for various users are stored in a memory to which the speech dialog system has access. Such a user profile contains the necessary address information of the respective user, such that the user has to indicate only the apparatus or transmission mode. A plurality of fax or telephone numbers or email addresses for a user may also be stored in the user profile and combined for example with particular keywords. The user has then to indicate only the relevant keywords in his/her address command, for example “office fax” or “home fax”. Such a service is especially simple to achieve when the user is known to the speech dialog system through earlier use of the speech dialog system or through an explicit initialization procedure and is identified at the beginning of the dialog, for example by transmission of the caller number.

If it is clear to the speech dialog system from the context that only one address is possible, a request for a specific address command is not necessary. For example, in the case of a user for whom only one fax machine and one email address are entered in a user profile, selection of the transmission mode “fax” or “email” indicates to which address the data are to be sent.

Likewise, if the user calls the speech dialog system from a cell phone and if the subscriber number of the cell phone has been ascertained, the speech dialog system may also send the message immediately to the relevant cell phone upon selection of the transmission mode “SMS” (or another cell phone short messaging service). This procedure is particularly suitable in the case of a relatively simple example of embodiment of the speech dialog system according to the invention, in which, in addition to the speech output device, only one additional formatting device for SMS or a corresponding short messaging service is present and the user has the choice only of having the data sent as a short message to the terminal used by him/her during the dialog, in addition to or as an alternative to acoustic output. Such a speech dialog system according to the invention, achievable at relatively low cost, is suitable for example for automated directory enquiry's, where expensive written confirmation is not necessary but it is very helpful to the user to receive the requested telephone numbers directly in savable form at the respective terminal.

The speech dialog system may to a considerable extent be provided inexpensively in the form of suitable software on a server, which is connected to the public communications networks over suitable interfaces. In this case, both the speech recognition device and the formatting devices and control device are preferably appropriate software modules. The speech output device may likewise take the form of a software module, for example a Text-To-Speech System (TTS System). In addition, however, the speech output device may also comprise a “prompt player”, which plays particular queries or constantly recurring announcements to the user as standardized sound files.

The various software modules may also, in this case, be installed on various, networked computers instead of on one individual computer. Thus, for example a computer which comprises the interfaces for connection with the public communications networks may comprise the control device, in particular a dialog control module, the speech output device and the necessary databases and formatting devices. The relatively computationally intensive automatic speech recognition may if required be performed by a speech recognition module which is installed on a second, particularly powerful, computer.

The invention will be further described with reference to examples of embodiments shown in the drawings to which, however, the invention is not restricted. In the Figures:

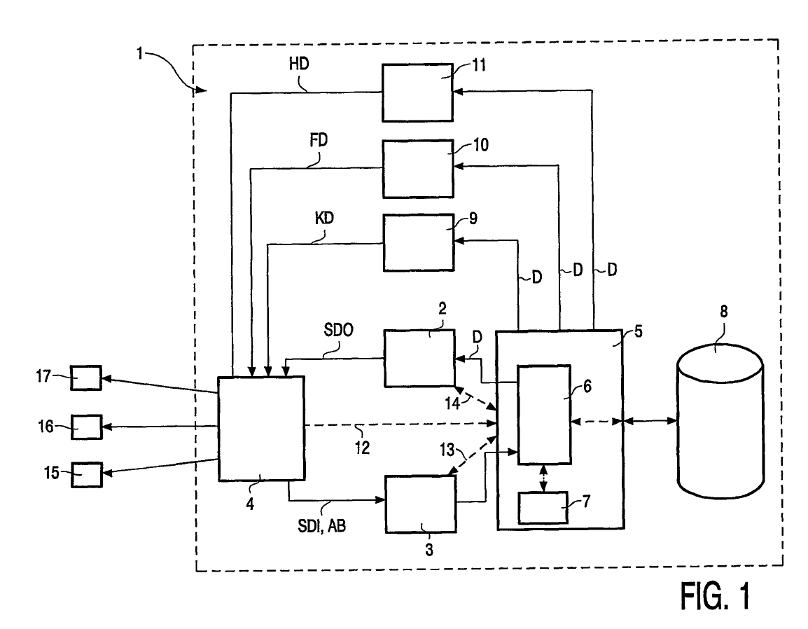

FIG. 1 is a schematic block diagram of a speech dialog system according to the invention,

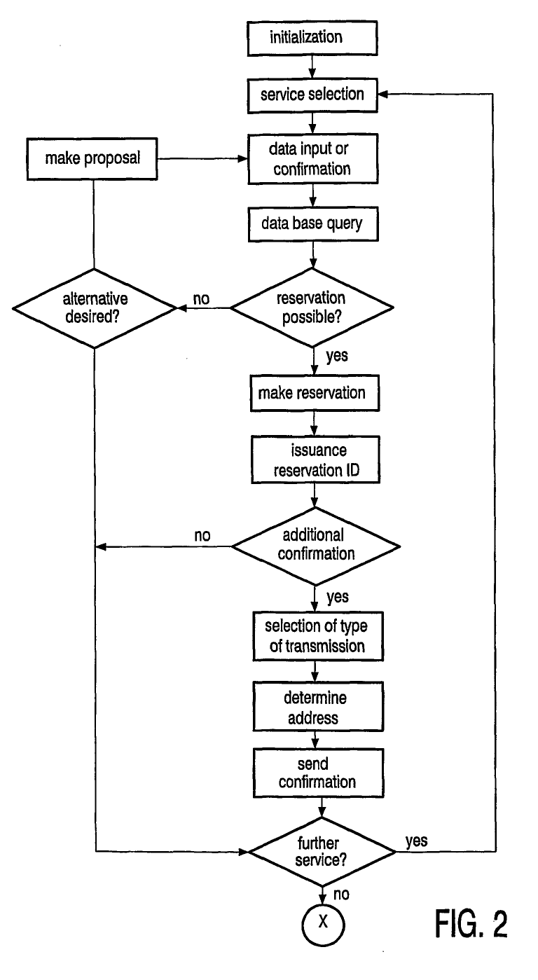

FIG. 2 is a flow chart for a possible dialog sequence using the speech dialog system to book a service with subsequent confirmation.

FIG. 1 is a relatively rough schematic representation showing only the components essential to the invention of the speech dialog system 1 according to the invention. The speech dialog system 1 here comprises a multifunctional interface 4, which forms the connection to the public communications networks and which allows the speech dialog system 1 to be contacted by a user by means of a telephone or a cell phone 15 over the usual mobile radio networks or landline networks. In addition, this multifunctional interface 4 also includes the possibility of sending an SMS to a cell phone 15 of the user and of sending a fax to a fax machine 16 of the user or an email to a mailbox 17 of the user via further outgoing channels.

The incoming speech data SDI transmitted by the user via the cell phone 15 and over the interface 4 to the speech dialog system 1 are firstly forwarded to a speech recognition device 3, which processes the speech data SDI for recognition purposes.

The information recognized by the speech recognition device 3 for the speech dialog system, such as user commands, search requests etc., are forwarded to a dialog control module 6 of a central control unit 5. This dialog control module 6 controls the course of the actual dialog with the user.

Control is effected by means of a dialog description, which is stored in a so-called “dialog description language” in the system, in this case in the memory 7. This may be any desired dialog description language. Conventional languages are for example process-oriented programming languages such as “C” or “C++” or so-called “hybrid languages”, which are declarative and process-oriented, such as for example “Voice XML” or “PSPHDLL”. These are languages similar in structure to the HTML language generally used for describing Internet pages. However, purely graphic dialog description languages may also be used, for example, in which the individual positions within the dialog procedure, for example a branch point or the call-up of a particular database, are represented in the form of a graphic block and connections between the blocks by lines.

The dialog control module ensures that particular information is output to the user at appropriate times, for example input requests (so-called “prompts”) or the like, in order to continue the dialog. This prompt output is effected over a speech output unit 2, for example a TTS module, which converts machine-readable data or text into speech data. The outgoing speech data SDO are then in turn transferred to the interface 4 for transmission to the cell phone 15 of the user. For status and access control, the speech recognition device 3, the speech generation device 2 and the interface 4 are additionally connected via appropriate control lines 12, 13, 14 or a bus to the central control unit 5.

Depending on the function of the speech dialog system 1, the central control unit 5 may access one or more databases, in order there to detect information desired by the user during the dialog. These may be databases within the speech dialog system 1 itself, or they may be external databases belonging to particular service providers or the like, which the speech dialog system 1 may access over the Internet or other networks. For the purpose of simplicity, FIG. 1 merely contains a symbolic representation of an internal database 8.

The data detected for the user from the database 8 or generated during the dialog, such as for example written confirmation of a booking procedure or the like, may be transmitted not only via the speech output device 2 but also by various other transmission modes, for example by fax, as an email or as an SMS. To this end, the speech dialog system 1 comprises according to the invention a plurality of formatting devices 9, 10, 11, i.e. conversion devices, which convert the data coming from the central control unit 5 and requiring transmission into a data format necessary for the respective transmission mode.

In detail, the speech dialog system 1 illustrated in FIG. 1 comprises a first formatting device, which converts the data D into a short message format KD, for example into SMS format. The speech dialog system 1 additionally comprises a fax formatting device 10, which converts the data D into fax data format FD. Finally, the speech dialog system 1 comprises an email formatting device 11, which converts the data D into an email format MD or into a file format, which may be attached to a standard email. This attachment to the standard email is preferably effected within the email formatting device 11. The data KD, FD, MD coming from the respective formatting devices 9, 10, 11 are then passed to the multifunctional interface 4 and there sent via the appropriate output channel in the desired transmission mode to a fax machine 16, a user's mailbox 17 or the user's cell phone 15.

It should be expressly stated at this point that the structure illustrated in FIG. 1 is merely one possible example. A speech dialog system according to the invention may also physically take the form of various other hardware and/or software architectures. Thus, for example, the various formatting devices may also be directly incorporated into the interface, or the speech dialog system comprises a separate interface for each transmission mode, which interface is connected downstream of the respective formatting device. Likewise, the speech dialog system may also comprise additional components, not described here, for example a “prompt player” or the like. Moreover, the speech dialog system may also comprise further formatting devices for other transmission modes than those explicitly mentioned above.

FIG. 2 is a flow chart of a dialog sequence possible when using the speech dialog system.

Dialog begins with initialization, in which the user is greeted by the speech dialog system and has optionally to identify him/herself by giving his/her name and possibly a password. At such a stage, identification of the caller using CLI could also be performed, for example.

Next, the user has the option of selecting the desired service. If the speech dialog system is one which offers only one type of service, this step may be omitted. In the present example of embodiment, it is assumed that the user wishes to book a hotel room.

To this end, the user firstly inputs the necessary data, such as for example the name or address of a hotel, the type of room and the desired date. The speech dialog system then performs a database interrogation, in order to obtain up-to-date data about the number of bookings already received by the relevant hotel. It is then established whether a booking is possible. If this is not the case, the user is asked whether he/she wants an alternative. If he/she says yes, the speech dialog system makes a suggestion, which the user has then merely to confirm, whereupon the database interrogation is performed and clarification is obtained as to whether a booking is possible. If the user does not wish to receive an alternative suggestion, he/she is asked in the next step whether he/she wants another service. If yes, the dialog starts again from the service selection point, otherwise the dialog is terminated.

If it is established that a booking is possible, the booking is performed in the database in a further step and a booking ID is issued in a subsequent step, which indicates under which number the booking was made. The user is then asked whether he/she would like an additional confirmation. If the user says no, the dialog system then asks whether the user requires another service. If yes, the sequence starts again at service selection, otherwise the dialog is terminated.

However, if the user does want an additional confirmation, the transmission mode is selected at the next point, in that the dialog system firstly checks whether a transmission mode select command is already contained in the response to the query relating to the additional confirmation, for example if the user has already answered “Yes, by fax”, and if not it outputs an appropriate prompt to the user, whereby he/she is asked to input a transmission mode select command.

The address is then specified to which the confirmation is to be sent. For example, if the transmission mode “fax” is chosen, the user is asked for a fax number.

In the next step, the written confirmation is sent to the fax indicated by the user. After this written confirmation has been sent, the user is asked by the dialog system whether he/she requires another service. If he/she says yes, the dialog starts again with service selection. Otherwise, the dialog is terminated.

It is clear that the described sequence may also be changed in various ways, without the essential concept of the invention being affected thereby. Thus, for example, it is easily possible additionally to provide speech outputs for confirmation at any desired points within the dialog. In particular, after selection of the transmission mode and after entry of the address of the device or of the subscriber number to which the data are to be sent, the following confirmation may be provided: “The desired information is being sent to your fax terminal, no. ‘123456789’.

The invention provides a simple way of allowing considerably more convenient utilization of speech dialog systems, since the user no longer has to remember or write down information obtained from the speech dialog system. Moreover, the invention opens up further possible applications for speech dialog systems, in areas in which for example for legal reasons written confirmation or the like is sensible or indeed necessary.

1. A method of operating a speech dialog system (1), which communicates with a user using a speech recognition device (2) and a speech output device (3), wherein the speech dialog system transmits to the user data (D) detected and/or generated for the user on the basis of the dialog, characterized in that, after receiving a user's transmission mode select command (AB), the speech dialog system formats the data (D) to be transmitted to the user in a data format suitable for the selected transmission mode and sends them via an interface (4) suitable for this transmission mode.

2. A method as claimed in claim 1, characterized in that the transmission mode select command (AB) indicates a plurality of transmission modes and the speech dialog system (1) sends the data (D) in each of the indicated transmission modes.

3. A method as claimed in claim 1, characterized in that in one selected transmission mode, transmission of the data is possible in different data formats and the speech dialog system formats the data and sends them in accordance with a data format select command received from the user.

4. A method as claimed in claim 1, characterized in that the user transmits an address command to the speech dialog system, to which address the data are to be transmitted in accordance with the transmission mode.

5. A method as claimed in claim 4, characterized in that the speech dialog system determines an address to which the data are to be transmitted in accordance with the transmission mode, on the basis of the selected transmission mode and/or the address command using additionally detected address information.

6. A method as claimed in claim 1, characterized in that the address to which the data are to be transmitted upon selection of a particular transmission mode and/or the additional address information are stored in a user profile of the speech dialog system assigned to the respective user.

7. An automatic speech dialog system (1)
having a speech recognition device (2) and a speech output device (3) for communicating with a user
and having means for detecting and/or generating particular data (D) for the user as a function of a dialog with the user and transmitting them to the user,
characterized by at least one additional formatting device (9, 10, 11) for formatting the data (D) in a data format suitable for a further transmission mode in addition to or as an alternative to the speech output,
and a control means (5) for receiving a user's transmission mode select command (AB) via the speech recognition device (3) for selection of a particular transmission mode and for controlling the speech dialog system (1) in such a way that, as a function of the transmission mode select command (AB), the data (D) are formatted by means of the appropriate formatting device (9, 10, 11) in accordance with the selected transmission mode and sent over a suitable interface (4).

8. A speech dialog system as claimed in claim 7, characterized by a memory means, for storing for various users the addresses to which the data are to be transmitted upon selection of a particular transmission mode and/or address information required therefor.

9. A computer program with program code means, for performing all the steps of a method as claimed in claim 1, if the program is performed on a speech dialog system computer.

10. A computer program with program code means as claimed in claim 9, which are stored on a computer-readable data storage medium.
